(19) United States
(12) Patent Application Publication
(10) Pub. No.: US 2019/0251075 A1
(43) Pub. Date: Aug. 15, 2019

(54) ASSET MANAGEMENT METHOD AND APPARATUS, AND ELECTRONIC DEVICE

(71) Applicant: Alibaba Group Holding Limited, George Town (KY)

(72) Inventor: Xuebing Yan, Hanzghou (CN)

(73) Assignee: Alibaba Group Holding Limited, George Town (KY)

(21) Appl. No.: 16/275,811

(22) Filed: Feb. 14, 2019

(30) Foreign Application Priority Data
Feb. 14, 2018 (CN) 201810151617.1

(51) Int. Cl. G06F 16/23; G06F 16/22

(52) U.S. Cl. CPC G06F 16/2365; G06F 16/22

(57) ABSTRACT

This specification describes techniques for managing assets in a blockchain. One example method includes receiving, from a target user recorded in a distributed database of a blockchain network, a user input including a request to convert an asset object from a first asset type to a second asset type, in response to receiving the user input, determining a contract object published in the blockchain network and corresponding to the first asset type, converting the asset object of the first asset type into the asset object of the second asset type, and updating a target object by adding the asset object of the second asset type to the target object that was generated using the contract object for the asset object of the first asset type.

### CROSS-REFERENCE TO RELATED APPLICATIONS

This application claims priority to Chinese Patent Application No. 201810151617.1, filed on Feb. 14, 2018, which is hereby incorporated by reference in its entirety.

### TECHNICAL FIELD

One or more implementations of the present specification relate to the field of blockchain technologies, and in particular, to an asset management method and apparatus, and an electronic device.

### BACKGROUND

The blockchain technology is a new technology, and in the technology, several computing devices jointly participate in “transaction recording” and jointly maintain a complete distributed database. The blockchain technology has the features of decentralization, openness and transparency, and each computing device can participate in database recording, and quick data synchronization can be achieved between computing devices. As such, the blockchain technology is used to build a decentralized system and collect various execution programs in the distributed database of the blockchain for automatic execution. These operations have been widely applied in many fields. For example, in the field of financial technologies, the blockchain technology is used to build a P2P payment platform and publish execution programs such as smart contracts on the blockchain. The point-to-point secured payment can be implemented between different users without using the financial institutions such as the bank.

### SUMMARY

The present specification provides an asset management method, including the following: receiving, by a node device in a blockchain, an asset object conversion request, where the asset object conversion request includes an asset object of a first asset type to be converted and a second asset type to be obtained after conversion; upon the asset object conversion request, invoking a contract object published on the blockchain and corresponding to the second asset type, and converting the asset object of the first asset type into the asset object of the second asset type; and adding the asset object of the second asset type obtained after conversion to a target object that holds the asset object of the first asset type.

Optionally, a first execution program used to convert an asset type, a second execution program used to create an asset object, and a conversion rule between the asset object of the first asset type and the asset object of the second asset type are declared in the contract object; and the invoking a contract object published on the blockchain and corresponding to the second asset type, and converting the asset object of the first asset type into the asset object of the second asset type includes the following: invoking the first execution program declared in the contract object published on the blockchain and corresponding to the second asset type, and converting the asset object of the first asset type into the asset object of the second asset type based on the conversion rule; and further invoking the second execution program declared in the contract object published on the blockchain and corresponding to the second asset type, to create the asset object of the second asset type obtained after conversion.

Optionally, the conversion rule includes the following: converting the asset object of the first asset type into the asset object of the second asset type that has the same value as the asset object of the first asset type.

Optionally, the adding the asset object of the second asset type obtained after conversion to a target object that holds the asset object of the first asset type includes the following: removing address information of the asset object of the first asset type from the target object that holds the asset object of the first asset type, adding the address information of the asset object of the first asset type to an asset holding object that holds the asset object of the second asset type in a target member that publishes the contract object, and adding the asset object of the second asset type obtained after conversion to the target object.

Optionally, the adding the asset object of the second asset type obtained after conversion to a target object that holds the asset object of the first asset type includes the following: modifying address information of the asset object of the first asset type in the target object that holds the asset object of the first asset type to address information of the asset object of the second asset type obtained after conversion.

Optionally, an object supported by the blockchain includes an address field, and the address field is used to maintain address information of an asset object held by an object.

Optionally, an object supported by the blockchain includes a code field, and the code field is used to maintain execution code related to an execution program declared by an object.

Optionally, the asset holding object includes the following: an asset holding object specified by the target member; or an asset holding object that is declared in the contract object corresponding to the second asset type and that corresponds to the target member.

Optionally, an object supported by the blockchain includes an account object, a contract object, and an asset object; and an object that holds an asset object includes any one of an account object, a contract object, and an asset object.

Optionally, the blockchain is a consortium blockchain, and a target member in the blockchain is a consortium member that has asset object creation permission in the consortium blockchain.

The present specification further provides an asset management apparatus, including the following: a receiving module, configured to receive an asset object conversion request, where the asset object conversion request includes an asset object of a first asset type to be converted and a second asset type to be obtained after conversion; a conversion module, configured to upon the asset object conversion request, invoke a contract object published on a blockchain and corresponding to the second asset type, and convert the asset object of the first asset type into the asset object of the second asset type; and an adding module, configured to add the asset object of the second asset type obtained after conversion to a target object that holds the asset object of the first asset type.

Optionally, a first execution program used to convert an asset type, a second execution program used to create an asset object, and a conversion rule between the asset object of the first asset type and the asset object of the second asset type are declared in the contract object; and the invoking a contract object published on the blockchain and corresponding to the second asset type, and converting the asset object of the first asset type into the asset object of the second asset type includes the following: invoking the first execution program declared in the contract object published on the blockchain and corresponding to the second asset type, and converting the asset object of the first asset type into the asset object of the second asset type based on the conversion rule; and further invoking the second execution program declared in the contract object published on the blockchain and corresponding to the second asset type, to create the asset object of the second asset type obtained after conversion.

Optionally, the conversion rule includes the following: converting the asset object of the first asset type into the asset object of the second asset type that has the same value as the asset object of the first asset type.

Optionally, the adding module is configured to remove address information of the asset object of the first asset type from the target object that holds the asset object of the first asset type, add the address information of the asset object of the first asset type to an asset holding object that holds the asset object of the second asset type in a target member that publishes the contract object, and add the asset object of the second asset type obtained after conversion to the target object.

Optionally, the adding module is configured to modify address information of the asset object of the first asset type in the target object that holds the asset object of the first asset type to address information of the asset object of the second asset type obtained after conversion.

Optionally, an object supported by the blockchain includes an address field, and the address field is used to maintain address information of an asset object held by an object.

Optionally, an object supported by the blockchain includes a code field, and the code field is used to maintain execution code related to an execution program declared by an object.

Optionally, the asset holding object includes the following: an asset holding object specified by the target member; or an asset holding object that is declared in the contract object corresponding to the second asset type and that corresponds to the target member.

Optionally, an object supported by the blockchain includes an account object, a contract object, and an asset object; and an object that holds an asset object includes any one of an account object, a contract object, and an asset object.

Optionally, the blockchain is a consortium blockchain, and a target member in the blockchain is a consortium member that has asset object creation permission in the consortium blockchain.

The present specification further provides an electronic device, including the following: a processor; a memory, configured to store a machine executable instruction, where by reading and executing the machine executable instruction that is stored in the memory and that corresponds to blockchain-based asset management control logic, the processor is prompted to: receive an asset object conversion request, where the asset object conversion request includes an asset object of a first asset type to be converted and a second asset type to be obtained after conversion; upon the asset object conversion request, invoke a contract object published on the blockchain and corresponding to the second asset type, and convert the asset object of the first asset type into the asset object of the second asset type; and add the asset object of the second asset type obtained after conversion to a target object that holds the asset object of the first asset type.

According to the previously described implementations, a user can initiate an asset object conversion request, and declare the asset object of the first asset type to be converted and the second asset type to be obtained after conversion in the asset object conversion request. The node device can invoke the contract object published on the blockchain and corresponding to the second asset type, to convert the asset object of the first asset type into the asset object of the second asset type and then add the asset object of the second asset type obtained after conversion to the target object that holds the asset object of the first asset type. As such, assets in the real world can be converted into digital assets held by the user on the blockchain, and the type conversion of the assets can be completed online based on the blockchain.

### BRIEF DESCRIPTION OF DRAWINGS

FIG. 1 is a flowchart illustrating an asset management method, according to an example implementation;

FIG. 2 is a schematic structural diagram illustrating an electronic device, according to an example implementation;

FIG. 3 is a block diagram illustrating an asset management apparatus, according to an example implementation; and

FIG. 4 is a flowchart illustrating an example of a computer-implemented method for asset management, according to an implementation of the present disclosure.

### DESCRIPTION OF IMPLEMENTATIONS

The present specification is intended to disclose a technical solution for converting asset object types in a blockchain.

During implementation, a target member in the blockchain can publish, on the blockchain, a contract object (smart contract) corresponding to a type of an asset object. The created contract object is used to manage the asset object, and a user who accesses the blockchain can create an asset object on the blockchain and complete online management of the held asset object on the blockchain by invoking the previously described contract object.

In one aspect, the user who accesses the blockchain can initiate an asset object creation request to the blockchain to invoke the previously described contract object to create an asset object, and then add address information of the created asset object to a target object that holds the asset object. For example, an execution program used to create an asset object can be pre-declared in the contract object. In this case, an asset object can be created by invoking the execution program.

In another aspect, the user who accesses the blockchain can initiate an asset object conversion request to the blockchain when requesting to convert an asset type of the held asset object. After receiving the asset object conversion request, a node device in the blockchain can respond to the asset object conversion request. The node device can invoke the contract object published on the blockchain and corresponding to the second asset type, to convert the asset object of the first asset type into the asset object of the second asset type and then add the asset object of the second asset type obtained after conversion to the target object that holds the asset object of the first asset type. As such, asset type conversion of the held asset object is completed.

According to the previously described implementation, a user can initiate an asset object conversion request, and declare the asset object of the first asset type to be converted and the second asset type to be obtained after conversion in the asset object conversion request. The node device can invoke the contract object published on the blockchain and corresponding to the second asset type, to convert the asset object of the first asset type into the asset object of the second asset type and then add the asset object of the second asset type obtained after conversion to the target object that holds the asset object of the first asset type. As such, assets in the real world can be converted into digital assets held by the user on the blockchain, and the type conversion of the assets can be completed online based on the blockchain.

The following describes the present specification by using specific implementations with reference to specific application scenarios.

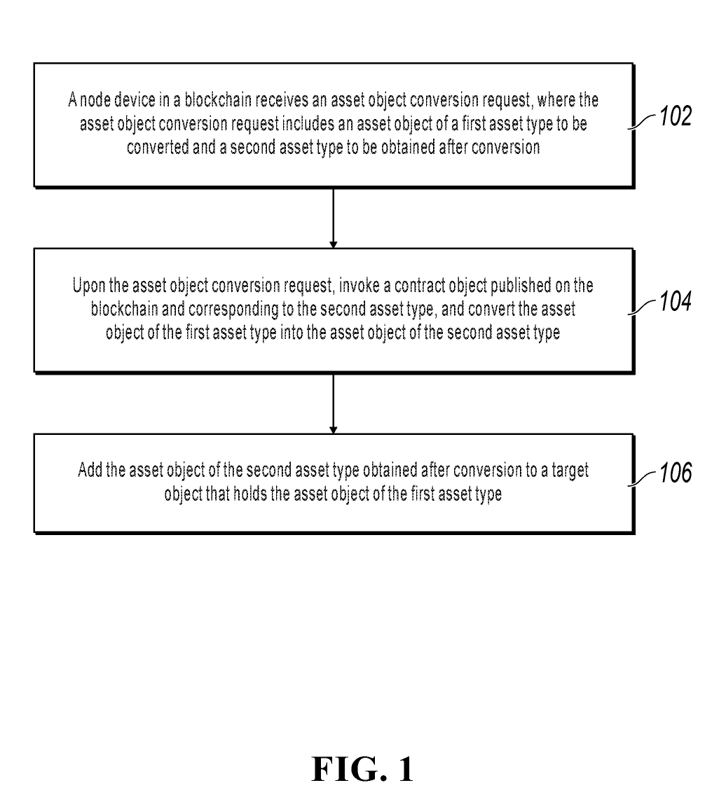

FIG. 1 illustrates an asset management method, according to an implementation of the present specification. The method is applied to a node device in a blockchain, and the node device performs the following steps:

Step 102: The node device in the blockchain receives an asset object conversion request, where the asset object conversion request includes an asset object of a first asset type to be converted and a second asset type to be obtained after conversion.

Step 104: Upon the asset object conversion request, invoke a contract object published on the blockchain and corresponding to the second asset type, and convert the asset object of the first asset type into the asset object of the second asset type.

Step 106: Add the asset object of the second asset type obtained after conversion to a target object that holds the asset object of the first asset type.

The blockchain described in the present specification can include any type of blockchain network that can cover an asset object in supported objects.

For example, in a conventional blockchain, a supported object usually includes only an account object and a contract object. In the present specification, an object supported by the blockchain can be extended. That is, an asset object can be supported in addition to the existing account object and contract object supported by the blockchain.

A type of the blockchain described in the present specification is not limited, and can be a consortium blockchain, or can be a blockchain (such as a private blockchain or a public blockchain) other than the consortium blockchain.

The previously described contract object can include a smart contract program. The program is published on the blockchain by the target member in the blockchain, and is included in a distributed database (that is, a blockchain ledger) of the blockchain and is used to manage an asset object supported by the blockchain. The user who accesses the blockchain can create an asset object on the blockchain and complete online management of the held asset object on the blockchain by invoking the previously described contract object.

For example, the blockchain can be a consortium blockchain including several financial institutions that are consortium members. In this case, the target member in the blockchain can be a consortium member in the consortium blockchain and is a financial institution that has asset object creation permission. A distributed smart contract platform can be built by using the consortium blockchain. An operator of the smart contract platform can extend an object type supported by the smart contract platform. That is, an asset object can be supported in addition to the existing account object and contract object supported by the platform. As such, as a consortium member, a financial institution can create a new asset type on the platform by publishing a smart contract on the blockchain, and then the user who accesses the blockchain can create an asset object and complete the online management of the held asset object by invoking the smart contract.

In the present specification, a type of a request initiated by the user who accesses the blockchain on the blockchain can be a transaction used in a conventional blockchain.

For example, the user who accesses the blockchain can initiate a transaction in the blockchain for creating an asset object, to invoke a contract object that has been published on the blockchain to create an asset object, or can initiate a transaction in the blockchain for updating a status of an asset object, to invoke the contract object that has been published on the blockchain to complete the asset status update of the asset object.

In some implementations, other than a transaction type, a type of the request initiated by the user who accesses the blockchain on the blockchain can be an instruction, a message, etc., that are in another form and of a standard data structure. The type is not limited in the present specification. In the following implementations, the description is made by using an example that the type of the request initiated by the user who accesses the blockchain on the blockchain is a transaction.

The previously described asset object can include a smart asset object, the smart asset object is used to maintain a smart asset and corresponds to any type of real asset of the user in the real world, and the smart asset can be processed in the blockchain by using the smart asset object. For example, the smart contract in the blockchain is particularly suitable for processing the smart asset object. The smart asset corresponds to, but is not limited to, the type of the real asset of the user in the real world. Implementations are not limited in the present specification.

For example, the blockchain is a consortium blockchain including several financial institutions, in actual applications, any form of offline asset of a user, for example, a fund, a real property, a stock, a mortgage contract, a bill, or an account receivable can be packaged into a digital asset by a financial institution that manages a node device on the consortium blockchain, and is created and published in a distributed database of the consortium blockchain.

The following uses specific implementations to describe the technical solutions of the present specification in detail with reference to “blockchain object extension”, “contract object publishing”, “asset object creation”, and “asset object type conversion”.

(1) Blockchain Object Extension

In the present specification, when building a blockchain network, the operator of the previously described blockchain can extend an object supported by the blockchain.

In a conventional blockchain (for example, the Ethereum), an object supported by the blockchain usually includes only two categories: an account object and a contract object. In the present specification, an object supported by the blockchain can be extended. That is, an asset object can be supported in addition to the existing account object and contract object supported by the blockchain.

In the present specification, the object supported by the previously described blockchain can include three categories: an account object, a contract object, and an asset object. As such, in addition to an account and a smart contract created on the blockchain, the user who accesses the blockchain can also create a digital asset on the blockchain. As such, assets in the real world can be converted into digital assets that are published on the blockchain.

In a shown implementation, an object supported by the previously described blockchain can still be constituted by the following four types of attribute fields:

Balance field (address field): In the conventional blockchain (for example, the Ethereum), the balance field usually indicates a “balance”, and is used to indicate an amount of token money held by an object. In the present specification, the meaning of the balance field can be extended, and the balance field does not represent the “balance” any more, but is address information used to maintain an asset object held by the object. In actual applications, address information of a plurality of asset objects can be maintained in the balance field.

During implementation, the account object, the contract object, and the asset object illustrated above can hold the asset object corresponding to the address information by adding the address information of the asset object to the balance field. That is, in the present specification, in addition to the account object and the contract object illustrated above, the asset object can hold a virtual asset.

Storage field: The field is used to maintain various states of the object (an account state, a contract state, an asset state, etc.). In an example of an asset object, a financial institution that publishes the asset object, or an entity that has permission to update an asset object and is specified by the financial institution, can update a status of the asset object by modifying content of the storage field. For example, the previously described asset object is a digital asset obtained after an offline mortgage contract asset of a user is packaged. When the user's daily mortgage performance status changes, the financial institution that publishes the asset object, or the entity that has permission to update an asset object and is specified by the financial institution, can synchronously update the content of the storage field in the asset object corresponding to the digital asset based on the change of the user's daily mortgage performance status.

Code field: The field is used to maintain execution code related to an execution program declared in an object (for example, various executable methods related to the code). That is, in the present specification, execution programs related to the account object, the contract object, and the asset object illustrated above can be declared in the object.

In an example of a contract object used to manage an asset object, any form of operation related to the asset object managed by the contract object can be pre-declared in an execution program form in the code field of the contract object, and the execution program can subsequently be invoked directly to complete the corresponding operation. For example, an execution program that is declared in the contract object that manages an asset object can usually include an execution program used to create an asset object, an execution program used to update an asset object, and an execution program used to transfer an asset object.

In addition to the execution code related to the execution program declared in the object, the previously described code field can maintain an invoking address of a contract object, an invoking parameter to be transferred during invocation of the contract object, etc.

Nonce field: The field is used to maintain the count of preventing replay attacks in the blockchain. The count can usually be a random number or a pseudo-random number that is used to prevent replay attacks in the blockchain.

(2) Contract Object Publishing

In a shown implementation, the previously described blockchain can be a consortium blockchain including several financial institutions that are consortium members. In this case, the target member in the blockchain can be a consortium member in the consortium blockchain and is a financial institution that has asset object creation permission.

A distributed smart contract platform can be built by using the consortium blockchain. A financial institution that has asset object creation permission in the consortium blockchain can create a new asset type on the platform by publishing a smart contract (the contract object) on the consortium blockchain.

During implementation, first, each financial institution in the consortium blockchain can be registered as a consortium member of the consortium blockchain, to obtain a pair of keys including a public key and a private key returned by the consortium blockchain. The public key is used as an account address of each financial institution on the consortium blockchain, and the private key is the only key for each financial institution to operate the account. Second, the operator of the consortium blockchain can authorize permission to create an asset object to all financial institutions that join the consortium blockchain. When obtaining the permission to create an asset object, the financial institution can create a smart contract and publish the smart contract on the consortium blockchain based on actual demands to create a new asset type.

The specific process of publishing the smart contract by the financial institution on the consortium blockchain is omitted in the present specification for simplicity, and a person skilled in the art can refer to records in the related technology.

For example, in actual applications, a financial institution can publish the created smart contract to the consortium blockchain by publishing a transaction to the consortium blockchain based on the private key it holds. When each consortium member in the consortium blockchain receives a transaction that is published by another financial institution by using a managed node device, consensus processing can be performed on a transaction published on the consortium blockchain in a recent period of time based on a consensus algorithm of the consortium blockchain, and after the consensus processing is completed, the smart contract published by the transaction is included in the distributed database of the consortium blockchain. The consensus algorithm supported by the consortium blockchain and the consensus algorithm-based consensus processing process of the consortium blockchain are not further described in detail in the present specification, and a person skilled in the art can refer to records in the related technology.

In the present specification, an execution program related to the asset type corresponding to the smart contract can be pre-declared in a smart contract corresponding to the newly added asset type and published on the consortium blockchain by a financial institution. These pre-declared execution programs can be carried in the code field of the contract object corresponding to the smart contract.

In a shown implementation, the execution program declared in the smart contract corresponding to the newly added asset type and published on the consortium blockchain by the financial institution can include an execution program used to create an asset object and an execution program used to transfer an asset object. The user who accesses the consortium blockchain can invoke an API provided by the consortium blockchain to publish a transaction that is signed based on the held private key to the consortium blockchain, and invoke an execution program declared in the previously described smart contract to create a virtual asset and complete the online transfer of the held virtual asset.

In some implementations, in addition to the previously described execution programs used to create and transfer an asset object, the execution program declared in the smart contract corresponding to the newly added asset type and published on the consortium blockchain by the financial institution can also include other execution programs related to the previously described asset object, for example, an execution program used to update an asset object. Details are omitted in the present specification for simplicity.

(3) Asset Object Creation

In the present specification, a user who requests to access the blockchain can also be registered in the consortium blockchain in advance, to obtain a pair of keys including a public key and a private key returned by the consortium blockchain. After the registration is completed, the consortium blockchain can create a corresponding account object for the user.

The registered user can publish, to the consortium blockchain by using an API provided by the consortium blockchain, a transaction that is used to request to create an asset object and signed based on the held private key.

After receiving the transaction that is published by the user based on the private key, a node device in the consortium blockchain connected to the registered user can first perform identity authentication on the user based on the public key corresponding to the private key held by the user. For example, in actual applications, the user can sign the initiated transaction based on the held private key, and the node device in the blockchain performs authentication on the signature based on the public key corresponding to the private key held by the user. If the signature authentication succeeds, the identity authentication on the user succeeds.

After the identity authentication succeeds, consensus processing can be performed on a transaction received within a period of time based on a consensus algorithm. In addition, after the consensus processing is completed, the transaction can be executed to determine the type of the asset object that the user requests to create (the consortium blockchain can publish a plurality of contract objects corresponding to different asset object types, and the user can request to create an asset object of one of the types).

For example, in an implementation, in the transaction that is published by the user based on the held private key, a type of the asset object that the user requests to create can be declared, and the node device that receives the transaction can determine, based on the information declared in the transaction, the type of the asset object that the user requests to create this time.

After determining the type of the asset object that the user requests to create, the node device can further query the contract object that has been published on the consortium blockchain and that corresponds to the type of the asset object that the user requests, and then can invoke, based on the invoking address of the contract object, the execution program that is declared in the contract object and used to create an asset object, to complete the creation of the asset object.

For example, in an implementation, the transaction that is published by the user based on the held private key can further carry parameters related to the asset object that the user requests to create, for example, the amount of assets that the user requests to create. When invoking the previously described contract object, the node device can transfer the parameters as the invoking parameters to the execution program that is declared in the contract object and used to create an asset object, and invoke the execution program to complete the creation of the asset object.

In a shown implementation, after the previously described process is used to create an asset object for the previously described user, the node device can further add the address information of the created asset object to the balance field of the target object that holds the asset object.

In the present specification, a process of generating the previously described address information of the asset object is not limited in the present specification. For example, in an implementation, the address information of the asset object can be a hash value obtained by performing hash calculation on content of the transaction for creating the asset object.

In a shown implementation, a target object that finally holds the created asset object includes the following two cases.

In one case, the target object that finally holds the created asset object can be a target object specified by the user to hold the asset object.

For example, during implementation, the user can pre-declare, in the published transaction for creating an asset object, a target object that can hold a newly created asset object; or the user can notify offline the specified target object that holds the created asset object to the financial institution that publishes the asset object.

In another case, the target object that finally holds the created asset object can be a target object pre-declared in the previously described contract object and used to hold the asset object. That is, when the financial institution publishes the contract object, a target object that can hold the asset object created by invoking the contract object can be pre-declared in the contract object.

For example, when publishing the previously described contract object, the financial institution can pre-declare, in the contract object, a whitelist of target objects that can hold the asset object created by invoking the contract object. Only a target object that hits the whitelist can hold the asset object created by invoking the previously described contract object.

In a shown implementation, the created asset object that can finally be held can include any one of an account object, a contract object, and an asset object supported by the consortium blockchain. That is, in the present specification, the account object, the contract object, and the asset object supported by the consortium blockchain can hold an asset object. The created asset object can be specified by the user, or declared in the contract object, and can be held by any one of the account object, the contract object, and the asset object.

For example, the user can specify asset object A as a target object that holds created asset object B, and can further complete packaging of asset object A and asset object B by adding address information of asset object B to a balance field of asset object A.

(4) Asset Object Type Conversion

In the present specification, the registered user can publish, to the consortium blockchain by using an API provided by the consortium blockchain, a transaction that is used to request to create an asset object and signed based on the held private key. In addition, in actual applications, a transaction signed based on the held private key and used to convert an asset object can be published to the consortium blockchain by using the previously described API, and type conversion is performed on the held asset object.

After receiving the transaction that is published by the user based on the private key, a node device in the consortium blockchain connected to the registered user can first perform identity authentication on the user based on the public key corresponding to the private key held by the user. After the identity authentication succeeds, consensus processing can be performed on a transaction received within a period of time based on a consensus algorithm. In addition, after the consensus processing is completed, the transaction can be executed.

The asset object of the converted first asset type can be declared in the transaction published by the user. For example, in an implementation, the address information of the converted asset object or identifier information of another type can be declared in the transaction published by the user based on the held private key, and the node device that receives the transaction can determine the converted asset object based on the information declared in the transaction.

Further, in addition to the asset object of the converted first asset type, the second asset type to be obtained after conversion this time can be declared in the published transaction too.

When executing the transaction, the node device in the blockchain can convert the asset object of the first asset type into the asset object of the second type by invoking the contract object published on the blockchain and corresponding to the second asset type.

In a shown implementation, in addition to the execution program used to create an asset object, an execution program used to convert an asset type and a conversion rule between the first asset type and the second asset type can be pre-declared in the contract object published on the blockchain and corresponding to the second asset type.

The specific rule content of the previously described conversion rule is not limited in the present specification. For example, in an implementation, the previously described conversion rule can include the following: converting the asset object of the first asset type into the asset object of the second asset type that has the same value as the asset object of the first asset type. That is, the user can convert the asset object of the first asset type declared by the user into the asset object of the second asset type that has the same value by initiating a transaction used to convert the asset type.

In some implementations, in addition to the conversion rule described above, other conversion rules can be included. For example, the asset object of the first asset type is converted into the asset object of the second asset type that has the same amount. Details are omitted in the present specification for simplicity.

The execution logic corresponding to the execution program used to convert the asset type is not limited in the present specification. A person skilled in the art can make customized execution logic based on actual demands. For example, in some cases, the execution program can be pre-declared in the code field of the contract object, and is used to describe the execution code of the previously described conversion rule.

In this case, when performing a transaction of converting an asset type of the asset object of the first asset type, the node device can invoke the execution program that is used to convert the asset type and declared in the previously described contract object, and convert the asset object of the first asset type into the asset object of the second asset type based on the conversion rule declared in the contract object. Then the node device further invokes the execution program used to create an asset object and declared in the previously described contract object, creates an asset object of the second asset type based on the previously described conversion result, and converts the asset object of the first asset type into the asset object of the second asset type.

For example, the previously described conversion rule is converting the asset object of the first asset type into the asset object of the second asset type that has the same value. After the previously described contract object is invoked to convert the asset object of the first asset type into the asset object of the second asset type that has the same value, the previously described execution program used to create an asset object can be further invoked to create the asset object of the second asset type that has the same value as the asset object of the first asset type.

In the present specification, after converting the asset object of the first asset type into the asset object of the second asset type by invoking the contract object corresponding to the second asset type, the node device can further add the asset object of the second asset type to the previously described target object that holds the asset object of the first asset type.

In the present specification, the previously described first asset type and the previously described second asset type can correspond to the same contract object, or can correspond to different contract objects.

In a scenario, the first asset type and the second asset type can belong to two different asset sub-types included in the asset type corresponding to the same contract object. In this case, the first asset type and the second asset type can correspond to the same contract object.

If the first asset type and the second asset type correspond to the same contract object, a related management operation can be performed on an asset object of the first asset type by using the contract object corresponding to the second asset type. For example, after the asset object of the first asset type is converted into the asset object of the second asset type by invoking the contract object corresponding to the second asset type, the asset object of the first asset type originally held by the user can be modified and changed by invoking the contract object corresponding to the second asset type.

In another scenario, the first asset type and the second asset type can respectively correspond to different asset types, and in this case, the first asset type and the second asset type can respectively correspond to different contract objects.

If the first asset type and the second asset type respectively correspond to different contract objects, a related management operation cannot be performed on an asset object of the first asset type by using the contract object corresponding to the second asset type. For example, after the asset object of the first asset type is converted into the asset object of the second asset type by invoking the contract object corresponding to the second asset type, the asset object of the first asset type originally held by the user cannot be modified and changed by invoking the contract object corresponding to the second asset type.

In a shown implementation, for the shown first scenario, if the first asset type and the second asset type respectively correspond to different contract objects, the user cannot manage an asset object of the first asset type by using the contract object corresponding to the second asset type. Therefore, when initiating a transaction of converting the held asset object of the first asset type into the asset object of the second asset type, the user may declare, in the transaction, that the “holding right” to the asset object of the first asset type is transferred to the publishing party of the contract object corresponding to the second asset type.

In this case, after completing the asset type conversion of the asset object of the first asset type by invoking the contract object corresponding to the second asset type, when adding the asset object of the second asset type obtained after conversion to the target object of the user that holds the asset object of the first asset type, the node device can first remove address information of the asset object of the first asset type from the balance field of the target object that holds the asset object of the first asset type, and add the address information of the asset object of the first asset type to an asset holding object that holds the asset object of the first asset type in a target member that publishes the contract object corresponding to the second asset type. As such, the “holding right” to the asset object of the first asset type is transferred to the publishing party that publishes the previously described contract object. Then, address information of the asset object of the second asset type obtained after conversion is added to the balance field of the target object that holds the asset object of the first asset type.

As such, when the previously described first asset type and the previously described second asset type correspond to different contract objects, the user can complete the asset type conversion of the asset object of the first asset type by transferring the “holding right” to the asset object of the first asset type to the publishing party that publishes the contract object corresponding to the second asset type. For example, the publishing party of the contract object corresponding to the second asset type is a financial institution. It is equivalent to a case that the user “impawns” the held asset object (which is not the asset object published by the financial institution) of the first asset type to the financial institution, and authorizes the financial institution to re-create an asset object of the second asset type for the user to complete the asset type conversion of the held asset object.

In a shown implementation, for the shown second scenario, if the first asset type and the second asset type correspond to the same contract object, the user can manage an asset object of the first asset type by using the contract object corresponding to the second asset type. Therefore, when initiating a transaction of converting the held asset object of the first asset type into the asset object of the second asset type, the user may not declare, in the transaction, that the “holding right” to the asset object of the first asset type is transferred to the publishing party of the contract object corresponding to the second asset type. Instead, the node device can modify and update the asset object corresponding to the first asset type by invoking the contract object corresponding to the second asset type.

In this case, after completing the asset type conversion of the asset object of the first asset type by invoking the contract object corresponding to the second asset type, when adding the asset object of the second asset type obtained after conversion to the target object of the user that holds the asset object of the first asset type, the node device can directly modify the address information of the asset object of the first asset type in the target object that holds the asset object of the first asset type to the address information of the asset object of the second asset type obtained after conversion.

As such, when the first asset type and the second asset type correspond to the same contract object, the user does not request to transfer the “holding right” to the asset object of the first asset type to the publishing party that publishes the contract object corresponding to the second asset type, so as to complete the asset type conversion of the asset object of the first asset type.

For example, the publishing party of the contract object corresponding to the second asset type is a financial institution. In this case, because asset objects of the first asset type and the second asset type both are asset objects issued by the financial institution, the user that holds the asset object of the first asset type does not request to transfer the asset object of the first asset type to the financial institution. Instead, the financial institution directly modifies the address information of the held asset object of the first asset type to the address information of the second asset type obtained after conversion by invoking the previously described contract object.

The asset holding object that holds an asset object of the previously described second asset type in the target member can include the following two cases.

In a case, the asset holding object that holds an asset object of the previously described second asset type in the target member can be an asset receiver object specified by the target member.

For example, during implementation, when requesting to add the asset object of the first asset type held by the user to the asset holding object corresponding to the target member, the node device can send a prompt message to access client software corresponding to the target member, so as to prompt the target member to specify an asset holding object that holds the asset object of the first asset type. After receiving the prompt message by using the access client software, the target member can manually submit the specified asset holding object to the node device.

In another case, the asset holding object that holds an asset object of the previously described second asset type in the target member can be an asset receiver object that is pre-declared in the previously described contract object corresponding to the second asset type. For example, the target member is a financial institution that accesses the consortium blockchain. When publishing the contract object, the financial institution can pre-declare, in the contract object, the asset receiver object that holds the asset object in the financial institution.

In the present specification, each of the target object that holds the asset object of the first asset type and the asset holding object corresponding to the publishing party of the contract object corresponding to the second asset type can include any one of an account object, a contract object, or an asset object supported by the consortium blockchain. That is, in the present specification, an asset object can be held by any one of the account object, the contract object, and the asset object that are supported by the consortium blockchain.

In some scenarios, a list of users having permission to invoke the contract object can usually be pre-declared in the previously described contract object. As such, in such a scenario, after receiving a transaction that is published by the user based on the private key, during identity authentication on the user, the node device in the blockchain can further verify whether the user has the permission to invoke the contract object. If the authentication succeeds, it is determined that the user has the permission to invoke the contract object, and then the execution program used to create an asset object or transfer an asset object and declared in the contract object is invoked, to complete the creation and transfer of the asset object.

For example, the list of users having permission to invoke the contract object and declared in the contract object can be a list of public keys held by a user. After receiving a transaction published by the user based on the private key, the node device in the blockchain can perform identity authentication on the user based on a public key in the public key list. If the authentication succeeds, it indicates that the user is a user that has permission to invoke the contract object.

In some implementations, in addition to the previously described public key-based method, there can be other methods for verifying whether the user submitting the transaction has the permission to invoke the contract object. Details are omitted in the present specification for simplicity.

According to the previously described implementations, in the present specification, a user can initiate an asset object conversion request, and declare the asset object of the first asset type to be converted and the second asset type to be obtained after conversion in the asset object conversion request. The node device can invoke the contract object published on the blockchain and corresponding to the second asset type, to convert the asset object of the first asset type into the asset object of the second asset type and then add the asset object of the second asset type obtained after conversion to the target object that holds the asset object of the first asset type. As such, assets in the real world can be converted into digital assets held by the user on the blockchain, and the type conversion of the assets can be completed online based on the blockchain.

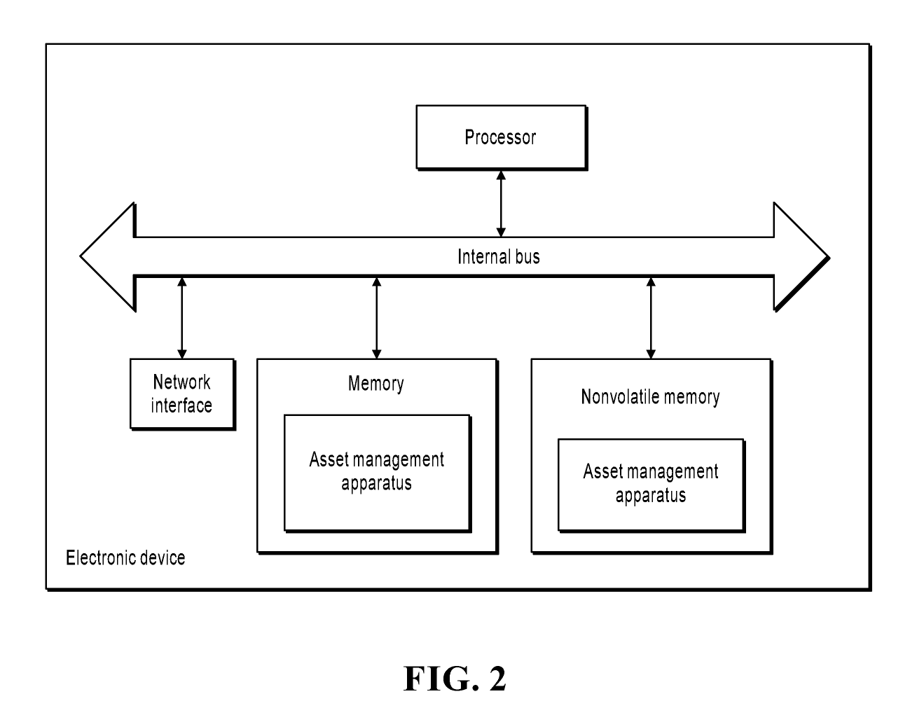

The present specification further provides an implementation of an asset management apparatus corresponding to the previously described method implementation. The implementation of the asset management apparatus in the present specification can be applied in an electronic device. The apparatus implementation can be implemented by software, hardware, or a combination of hardware and software. Software implementation is used as an example. As a logical apparatus, the apparatus is formed by reading a corresponding computer program instruction in a nonvolatile memory to a memory by a processor of an electronic device where the apparatus is located. In terms of hardware, FIG. 2 is a structural diagram illustrating hardware of the electronic device that the asset management apparatus of the present specification is located. In addition to the processor, the memory, a network interface, and the nonvolatile memory shown in FIG. 2, the electronic device that the apparatus is located in this implementation usually can include other hardware based on an actual function of the electronic device. Details are omitted here for simplicity.

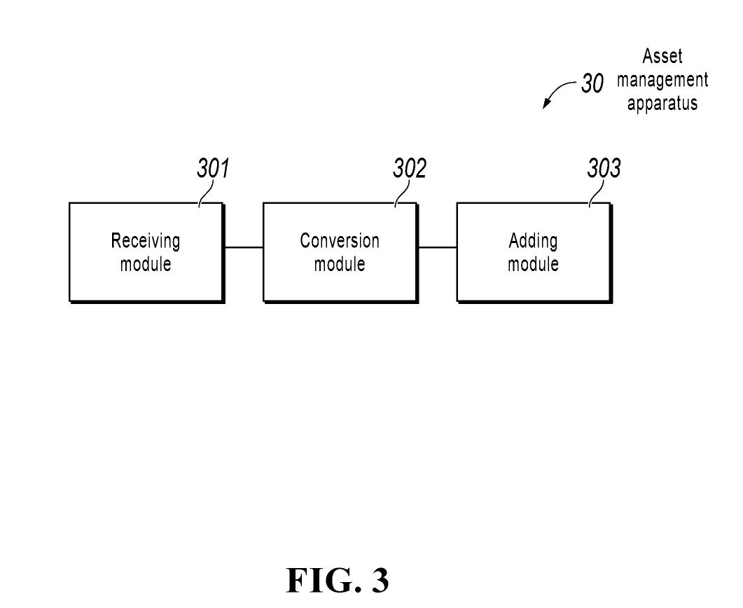

FIG. 3 is a block diagram illustrating an asset management apparatus, according to an example implementation of the present specification.

Referring to FIG. 3, the asset management apparatus 30 can be applied in the electronic device shown in FIG. 2, and include a receiving module 301, a conversion module 302, and an adding module 303.

The receiving module 301 is configured to receive an asset object conversion request, where the asset object conversion request includes an asset object of a first asset type to be converted and a second asset type to be obtained after conversion.

The conversion module 302 is configured to upon the asset object conversion request, invoke a contract object published on a blockchain and corresponding to the second asset type, and convert the asset object of the first asset type into the asset object of the second asset type.

The adding module 303 is configured to add the asset object of the second asset type obtained after conversion to a target object that holds the asset object of the first asset type.

In this implementation, a first execution program used to convert an asset type, a second execution program used to create an asset object, and a conversion rule between the asset object of the first asset type and the asset object of the second asset type are declared in the contract object.

The conversion module 302 is configured to invoke the first execution program declared in the contract object published on the blockchain and corresponding to the second asset type, and convert the asset object of the first asset type into the asset object of the second asset type based on the conversion rule; and further invoke the second execution program declared in the contract object published on the blockchain and corresponding to the second asset type, to create the asset object of the second asset type obtained after conversion.

In this implementation, the conversion rule includes the following: converting the asset object of the first asset type into the asset object of the second asset type that has the same value as the asset object of the first asset type.

In this implementation, the adding module 303 is configured to remove address information of the asset object of the first asset type from the target object that holds the asset object of the first asset type, add the address information of the asset object of the first asset type to an asset holding object that holds the asset object of the second asset type in a target member that publishes the contract object, and add the asset object of the second asset type obtained after conversion to the target object.

In this implementation, the adding module 303 is configured to modify address information of the asset object of the first asset type in the target object that holds the asset object of the first asset type to address information of the asset object of the second asset type obtained after conversion.

In this implementation, an object supported by the blockchain includes an address field, and the address field is used to maintain address information of an asset object held by an object.

In this implementation, an object supported by the blockchain includes a code field, and the code field is used to maintain execution code related to an execution program declared by an object.

In this implementation, the asset holding object includes the following: an asset holding object specified by the target member; or an asset holding object that is declared in the contract object corresponding to the second asset type and that corresponds to the target member.

In this implementation, an object supported by the blockchain includes an account object, a contract object, and an asset object; and an object that holds an asset object includes any one of an account object, a contract object, and an asset object.

In this implementation, the blockchain is a consortium blockchain, and a target member in the blockchain is a consortium member that has asset object creation permission in the consortium blockchain.

For an implementation process of functions and roles of each module in the apparatus, references can be made to an implementation process of a corresponding step in the previously described method. Details are omitted here for simplicity.

Because an apparatus implementation basically corresponds to a method implementation, for related parts, references can be made to related descriptions in the method implementation. The previously described apparatus implementation is merely an example. The modules described as separate parts may or may not be physically separate, and parts displayed as modules may or may not be physical modules, can be located in one position, or can be distributed on a plurality of network modules. Some or all of the modules can be selected based on actual requests to achieve the objectives of the solutions in the present specification. A person of ordinary skill in the art can understand and implement the implementations of the present specification without creative efforts.

The system, apparatus, or module illustrated in the previously described implementations can be implemented by using a computer chip or an entity, or can be implemented by using a product having a certain function. A typical implementation device is a computer, and the computer can be a personal computer, a laptop computer, a cellular phone, a camera phone, a smart phone, a personal digital assistant, a media player, a navigation device, an email receiving and sending device, a game console, a tablet computer, a wearable device, or any combination of these devices.

The present specification further provides an implementation of an electronic device corresponding to the previously described method implementation. The electronic device includes a processor and a memory configured to store a machine executable instruction, and the processor and the memory are usually connected to each other by using an internal bus. In other possible implementations, the device can further include an external interface to communicate with another device or component.

In this implementation, by reading and executing the machine executable instruction that is stored in the memory and that corresponds to asset management control logic, the processor is prompted to: receive, by a node device in a blockchain, an asset object conversion request, where the asset object conversion request includes an asset object of a first asset type to be converted and a second asset type to be obtained after conversion; upon the asset object conversion request, invoke a contract object published on the blockchain and corresponding to the second asset type, and convert the asset object of the first asset type into the asset object of the second asset type; and add the asset object of the second asset type obtained after conversion to a target object that holds the asset object of the first asset type.

In this implementation, a first execution program used to convert an asset type, a second execution program used to create an asset object, and a conversion rule between the asset object of the first asset type and the asset object of the second asset type are declared in the contract object.

By reading and executing the machine executable instruction that is stored in the memory and that corresponds to asset management control logic, the processor is prompted to: invoke the first execution program declared in the contract object published on the blockchain and corresponding to the second asset type, and convert the asset object of the first asset type into the asset object of the second asset type based on the conversion rule; and further invoke the second execution program declared in the contract object published on the blockchain and corresponding to the second asset type, to create the asset object of the second asset type obtained after conversion.

In this implementation, by reading and executing the machine executable instruction that is stored in the memory and that corresponds to asset management control logic, the processor is prompted to: remove address information of the asset object of the first asset type from the target object that holds the asset object of the first asset type, add the address information of the asset object of the first asset type to an asset holding object that holds the asset object of the second asset type in a target member that publishes the contract object, and add the asset object of the second asset type obtained after conversion to the target object.

In this implementation, by reading and executing the machine executable instruction that is stored in the memory and that corresponds to asset management control logic, the processor is prompted to: modify address information of the asset object of the first asset type in the target object that holds the asset object of the first asset type to address information of the asset object of the second asset type obtained after conversion.

A person skilled in the art can easily figure out another implementation solution of the present specification after considering the present specification and practicing the present disclosure here. The present specification is intended to cover any variations, uses, or adaptations of the present specification, and these variations, uses, or adaptations follow the general principles of the present specification and include common knowledge or conventional techniques that are not disclosed in the technical field of the present specification. The present specification and the implementations are merely considered as examples, and the actual scope and the spirit of the present specification are pointed out by the following claims.

It should be understood that the present specification is not limited to the precise structures that have been described above and shown in the drawings, and various modifications and changes can be made without departing from the scope of the present specification. The scope of the present specification is limited by the appended claims only.

The previous descriptions are merely preferred implementations of the present specification, but are not intended to limit the present specification. Any modification, equivalent replacement, or improvement made without departing from the spirit and principle of the present specification shall fall within the protection scope of the present specification.

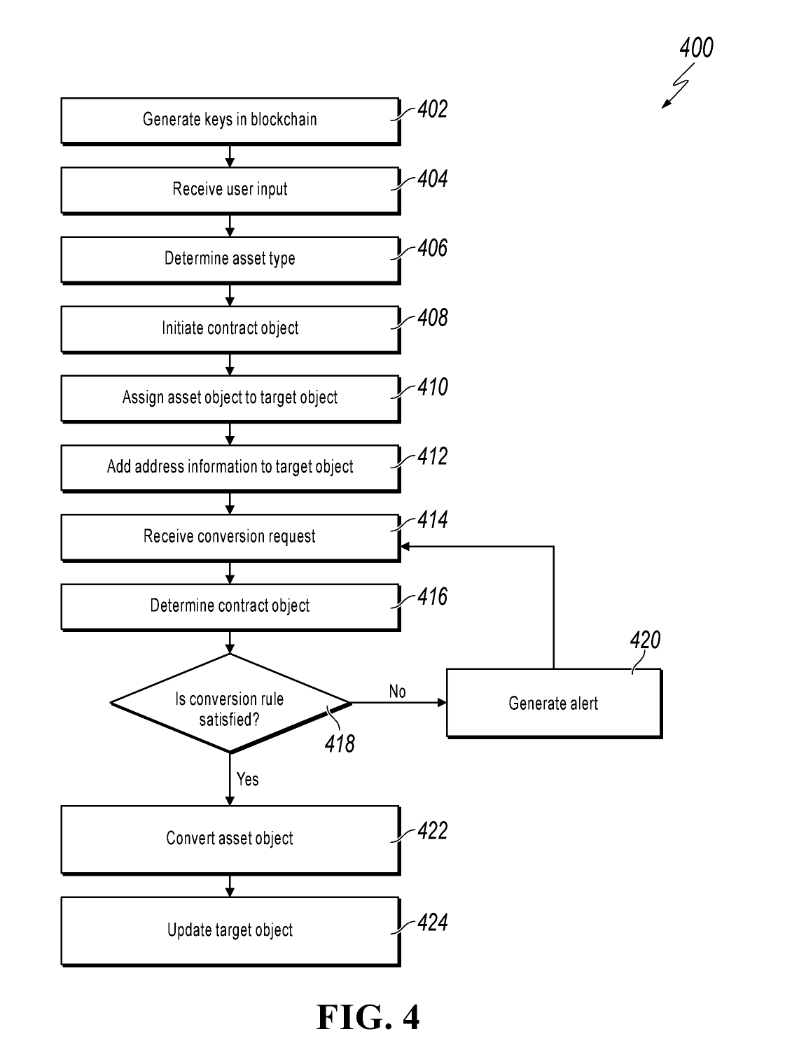

FIG. 4 is a flowchart illustrating an example of a computer-implemented method 400 for management of assets in a blockchain, according to an implementation of the present disclosure. For clarity of presentation, the description that follows generally describes method 400 in the context of the other figures in this description. However, it will be understood that method 400 can be performed, for example, by any system, environment, software, and hardware, or a combination of systems, environments, software, and hardware, as appropriate. In some implementations, various steps of method 400 can be run in parallel, in combination, in loops, or in any order.

At 402, keys are generated for a target user recorded in a distributed database of the blockchain network. The keys include a public key and a private key. In some implementations, the public key is associated with an account address of an institution in the blockchain. The private key can be configured to be used by the institution to operate the account. In some implementations, the blockchain network includes a consortium chain. The target member (user) in the blockchain network is a consortium member that has asset object generation and/or update authority in the consortium chain. The blockchain network includes one or more account objects and one or more contract objects. The objects of the blockchain network (e.g., account objects, contract objects, target objects, and asset objects) include one or more fields. For example, the fields can include one or more of the following: the IP configuration for the target user; DNS logs from the target user, including events such as DNS lookups, changes to DNS settings, and so forth; network firewall logs (and/or other security-related log files) from the target user, including events such as blocked or allowed network communications, and so forth; operating system (OS) logs from the target user, including events associated with the OS; port settings on the target user; user access logs from the target user, including successful and/or unsuccessful user attempts to transfer assets from or to the target user; and/or user privilege data from the target user, including particular access privileges for various users on the target user. The fields can also include one or more of an entity name, entity ID, target user ID, OS version information, and software version(s) for installed software, network router information, other DNS settings, firewall settings, port settings, IP whitelist and/or blacklist settings, and so forth. From 402, method 400 proceeds to 404.

At 404, a user input is received from the target user recorded in a distributed database of the blockchain network. The user input includes a request to generate an asset object in the blockchain network. The asset object includes a digital asset corresponding to a physical asset associated with the target user. The request includes an asset type specified by the target user. The asset type can be indicated by an identifier that corresponds one of a plurality of different types of asset objects that can be deployed in the consortium chain. From 404, method 400 proceeds to 406.

At 406, an asset type of the asset object is determined based on the user input. From 406, method 400 proceeds to 408.

At 408, the contract object is initiated in the blockchain network to generate the asset object based on the asset type. The asset object includes a digital asset corresponding to a physical asset associated with the target user. From 408, method 400 proceeds to 410.

At 410, the asset object is assigned to a target object of the target user. The target object includes an address field used to maintain address information of the asset object assigned to the target object. From 410, method 400 proceeds to 412.

At 412, the address information of the asset object is added to the target object. From 412, method 400 proceeds to 414.

At 414, a request to the asset object from a first asset type to a second asset type is received from the target user. The asset type of the asset object can be stored in the storage field of the target object. In some implementations, the asset object is a digital asset corresponding to a financial object. The asset type of the financial object can include a fund (fund equivalents), a real property, a stock, a mortgage contract, a bill, inventory, or an account receivable. In some implementations, the asset type includes a plurality of subtypes, such as subtypes associated with multiple currencies corresponding to a fund. From 414, method 400 proceeds to 416.

At 416, the contract object for the asset object of the first asset type is determined. For example, the contract object for the asset object of the first asset type is selected from a plurality of contract object stored in the blockchain network. From 416, method 400 proceeds to 418.

At 418, a determination is made as to whether a conversion rule is satisfied. In some implementations, the conversion rule includes a condition that requests the asset object of the second asset type to have an equivalent value as the asset object of the first asset type relative to a global conversion rate that is independent from the blockchain network. For example, the conversion rule for a currency conversion can include a current currency exchange rate to determine whether the values of the asset types are equivalent. The determination can include operations of reading and executing a machine executable instruction that is stored in the contract object and corresponds to the control logic of asset management. If it is determined that the conversion value of the second asset type is not equivalent to the original value of the first asset type, method 400 proceeds to 420. At 420, an alert is generated to indicate that the conversion of the asset object cannot be completed as requested. From 420, method 400 returns to 414.

Otherwise, at 422, if it is determined that the conversion value of the second asset type is equivalent to the original value of the first asset type, the asset object is converted from the first asset type to the asset object of the second asset type. From 422, method 400 proceeds to 424.

At 424, the target object that initially corresponded to the first asset type of the asset object is updated to reflect the conversion of the asset object to a second type. During the asset type update of the target object, the newly generated asset type of the asset object of the target user can be reflected by one or more fields of the target object. For example, the balance field can include an update of an amount of a second type of asset (e.g., token money) held by the converted asset object and the storage field can indicate the second type of asset that replaces the first asset type. In some implementations, updating the target object can include deleting a first address information of the asset object of the first asset type from the target object and adding a second address information of the asset object of the second asset type to the target object. In some implementations, updating the target object can include updating a nonce field of the target object that is configured to prevent replay attacks in the blockchain network. The fields of the target object can be updated using the contract object during an update process. After 424, method 400 can stop or return to 414.

Implementations of the present application can solve technical problems in managing assets in a blockchain. In some implementations, the blockchain is a distributed storage solution that provides immutable and tamper-resistant data transfer and storage, and the data is stored in a database of the blockchain in an encrypted form. Such security measures ensure that that system state data stored on the blockchain is not corrupted or altered by malicious processes. For example, an alteration of an asset-receiving object can be a tactic used by an attacker when a target user is compromised for fraudulent purposes, and storage of system state data on an immutable blockchain prevents the use of that tactic by an attacker. In some implementations, the blockchain headers from different payment applications across entities are cross-Merkelized or otherwise processed on the blockchain to further ensure the integrity of the data stored in the database of the blockchain.

In consideration of security and confidentiality, contract objects can be configured to perform privacy protection processing on the data associated with the asset object before generating the asset object and sending the address information to other platforms for processing. In addition, the asset transfer operation is configured such that it does not affect the overall data volume within the blockchain by deleting a data volume from a first location when adding the corresponding data volume in a second location. As such, the asset transfer operation does not lead to an exponential increase of data volume, which is a common problem associated with conventional methods of asset management.

Implementations of the present application provide methods and apparatuses for improving asset management. In some implementations, a processing platform (e.g., an payment processing server) obtains data that is to be validated and that corresponds to a predetermined feature from a data providing platform as a data group that is to be validated (e.g., a data group that corresponds to user transaction amounts). In addition, the processing platform can further obtain additional (e.g., historical) data associated with the asset that is to be validated by the predetermined transfer rule. The historical data may also corresponds to the same predetermined feature, and the comparison data group can be provided to a processing platform (e.g., a node of the blockchain network) for processing before the asset transfer. Then, the processing platform determines whether the asset transfer request satisfies the predetermined transfer rule. If the predetermined transfer rule is satisfied (e.g., there is no abnormal data), the processing platform can continue to transfer the asset. If the processing platform determines that there is abnormal data, the processing platform can start alerting, instruct related persons to analyze the cause of the data exception, and trigger related solutions.

In some implementations, the processing platform determines risk scores of asset transfers and transactions across multiple different entities, based on both transaction data for the transaction and system state data for the hosts involved in handling the transaction. The risk scores are examined to identify those transactions that are deemed high risk, with above-threshold scores. Such transactions can be blocked or queued for further examination in a case management system, for example. The system state data to be used for comparison, as well as the transaction data and risk score(s), can be stored on the blockchain that provides immutable, secure, and distributed data storage. Use of the blockchain facilitates the collection and analysis of a large amount of transaction data and system state data, which may grow over time as transaction traffic increases and/or transaction networks expand by adding more hosts to accommodate the increased traffic. Accordingly, through the use of a blockchain to store and analyze the data, implementations provide scalability with respect to the data extraction, analysis, and storage of the data. Moreover, because the blockchain is distributed across multiple network locations, implementations avoid the use of a centralized database for data storage and are therefore less vulnerable to corruption or deletion by malicious processes, in comparison to traditional, previously available risk analysis solutions that are vulnerable to attack at such a centralized storage hub.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method for asset management, the computer-implemented method comprising:
receiving, from a target user recorded in a distributed database of a blockchain network, a user input comprising a request to convert an asset object from a first asset type to a second asset type;
in response to receiving the user input, determining a contract object published in the blockchain network and corresponding to the second asset type;
converting the asset object of the first asset type into the asset object of the second asset type; and
updating a target object by adding the asset object of the second asset type to the target object that was generated using the contract object for the asset object of the first asset type.

2. The computer-implemented method of claim 1, wherein the contract object comprises a first execution program used to convert an asset type, a second execution program used to create the asset object, and a conversion rule between the first asset type and the second asset type.

3. The computer-implemented method of claim 2, wherein the conversion rule comprises:
the asset object of the first asset type is convertible into the second asset type, if the second asset type has an equivalent value as the asset object of the first asset type.

4. The computer-implemented method of claim 1, wherein adding the asset object of the second asset type to the target object comprises:
deleting a first address information of the asset object of the first asset type from the target object; and
adding a second address information of the asset object of the second asset type to the target object.

5. The computer-implemented method of claim 1, wherein the blockchain network comprises a consortium chain, and the target user in the blockchain network is a consortium member that has asset object generation authority in the consortium chain.

6. The computer-implemented method of claim 1, wherein the user input comprises a transaction corresponding to the asset object in the blockchain network.

7. The computer-implemented method of claim 1, wherein the target object comprises a nonce field that is configured to prevent replay attacks in the blockchain network.

8. A non-transitory, computer-readable medium storing one or more instructions executable by a computer system to perform operations comprising:
receiving, from a target user recorded in a distributed database of a blockchain network, a user input comprising a request to convert an asset object from a first asset type to a second asset type;
in response to receiving the user input, determining a contract object published in the blockchain network and corresponding to the second asset type;
converting the asset object of the first asset type into the asset object of the second asset type; and
updating a target object by adding the asset object of the second asset type to the target object that was generated using the contract object for the asset object of the first asset type.

9. The non-transitory, computer-readable medium of claim 8, wherein the contract object comprises a first execution program used to convert an asset type, a second execution program used to create the asset object, and a conversion rule between the first asset type and the second asset type.

10. The non-transitory, computer-readable medium of claim 9, wherein the conversion rule comprises: the asset object of the first asset type is convertible into the second asset type, if the second asset type has an equivalent value as the asset object of the first asset type.

11. The non-transitory, computer-readable medium of claim 8, wherein adding the asset object of the second asset type to the target object comprises:
deleting a first address information of the asset object of the first asset type from the target object; and
adding a second address information of the asset object of the second asset type to the target object.

12. The non-transitory, computer-readable medium of claim 8, wherein the blockchain network comprises a consortium chain, and the target user in the blockchain network is a consortium member that has asset object generation authority in the consortium chain.

13. The non-transitory, computer-readable medium of claim 8, wherein the user input comprises a transaction corresponding to the asset object in the blockchain network.

14. The non-transitory, computer-readable medium of claim 8, wherein the target object comprises a nonce field that is configured to prevent replay attacks in the blockchain network.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
receiving, from a target user recorded in a distributed database of a blockchain network, a user input comprising a request to convert an asset object from a first asset type to a second asset type;
in response to receiving the user input, determining a contract object published in the blockchain network and corresponding to the second asset type;
converting the asset object of the first asset type into the asset object of the second asset type; and
updating a target object by adding the asset object of the second asset type to the target object that was generated using the contract object for the asset object of the first asset type.

16. The computer-implemented system of claim 15, wherein the contract object comprises a first execution program used to convert an asset type, a second execution program used to create the asset object, and a conversion rule between the first asset type and the second asset type.

17. The computer-implemented system of claim 16, wherein the conversion rule comprises:
the asset object of the first asset type is convertible into the second asset type, if the second asset type has an equivalent value as the asset object of the first asset type.

18. The computer-implemented system of claim 15, wherein adding the asset object of the second asset type to the target object comprises:
deleting a first address information of the asset object of the first asset type from the target object; and
adding a second address information of the asset object of the second asset type to the target object.

19. The computer-implemented system of claim 15, wherein the blockchain network comprises a consortium chain, and the target user in the blockchain network is a consortium member that has asset object generation authority in the consortium chain.

20. The computer-implemented system of claim 15, wherein the user input comprises a transaction corresponding to the asset object in the blockchain network.
